(19) United States
(12) Patent Application Publication
(10) Pub. No.: US 2014/0244223 A1
(43) Pub. Date: Aug. 28, 2014

(54) Method For Simulating Circuitry By Dynamically Modifying Device Models That Are Problematic For Out-of-Range Voltages

(71) Applicant: TEXAS INSTRUMENTS INCORPORATED, Dallas, TX (US)

(72) Inventor: Gang Peter Fang, Plano, TX (US)

(73) Assignee: TEXAS INSTRUMENTS INCORPORATED, Dallas, TX (US)

(21) Appl. No.: 13/775,827

(22) Filed: Feb. 25, 2013

(51) Int. Cl. G06F 17/50

(52) U.S. Cl. CPC G06F 17/5009
USPC 703/2

(57) ABSTRACT

A simulation system (1) prevents failure of simulation computations to converge due to out-of-range conditions of a first device model including a first equation (Eqn.(1)) utilized in simulation computations involving the first device model by identifying an out-of-range condition (e.g., v_{d}>V₀) which is likely to prevent convergence of simulation computations involving the first equation during a simulation run, and by automatically providing a second equation (Eqn.(6) or Eqn.(9)) in place of the first equation (Eqn.(1)), wherein the second equation defines a simpler mathematical function than the first equation and is more likely than the first equation to allow simulation computations to converge to a desired solution during the simulation run. The method includes automatically determining any time at which the out-of-range condition no longer exists and automatically modifying the first device model by replacing the second equation with the first equation.

### BACKGROUND OF THE INVENTION

The present invention relates generally to simulation of the operation of electronic circuits, especially integrated circuits. The invention relates more particularly to a technique for reducing the amount of time and difficulty of accurately simulating circuit performance in cases wherein the various parameters for mathematical simulation models of devices/components in a simulator experience or assume “out-of-range” values during simulation of the operation of circuits containing the devices/components.

“Compact” (i.e., sufficiently simple to be incorporated in circuit simulators) semiconductor device models are mathematical descriptions or equations of semiconductor devices in a circuit used in circuit simulators, and serve as an important vehicle for achieving suitable communication between integrated circuit designers and integrated circuit fabrication facilities or “foundries”. When characterizing a semiconductor process, foundries fabricate a number of devices with various geometric sizes and physical parameters on test wafers. Those devices are then measured over a normal operating range, and the measured data are used to extract the compact device models. The compact device models are made available to circuit designers as a part of a process design kit (PDK).

Circuit analysis software based on or similar to the well-known public domain simulation engine SPICE (Simulation Program with Integrated Circuit Emphasis) is widely used in the semiconductor industry. However, strong-nonlinear (e.g., exponential) device characteristics in some compact models are known to cause convergence problems in a SPICE or SPICE-like circuit simulator employing the well known Newton-Raphson numerical analysis algorithm. Limiting algorithms (e.g., by Bhattacharya & Mazumd) have been used to deal with the convergence problems by limiting the magnitudes of the changes between Newton-Rapson iterations. Since compact semiconductor device models are generally designed using different modeling equations characterizing different operating regions of nonlinear devices (such as transistors and diodes), discontinuities of equations and derivatives thereof may exist in boundaries between the different regions. Various techniques (e.g., as subsequently described in the Liu et al. reference) are known for dealing with such discontinuities. It should be noted that the above mentioned limiting algorithms are used to deal with “strong” nonlinear characteristics, but not with discontinuities.

The accuracy of circuit simulation results that correspond to various variables and parameters of a circuit design depends on the accuracy of the compact device models. Note that the term “parameters” herein refers to intrinsic constants or coefficients (for example, constants representative of the width and length of a MOSFET) for a “device instance” that does not change during a DC sweep or a transient run of a simulator. The term “device instance” as used herein refers to an individual device in a circuit. (It is referred to as a “device instance” (rather than just a “device”) because sometimes system engineers refer to the entire integrated circuit chip as a “device”.) It should be understood that many device instances can be modeled by the same device model. For example, a circuit may include half of a million device instances even though the circuit is simulated using only 200 device models. Note that device currents and voltages are referred to herein as “variables” rather than “parameters”.

The semiconductor device models typically are accurate over particular “normal ranges” of the voltages applied to the “terminals” of device models used during simulation of circuit performance. However, during a DC simulation or transient simulation of the operation of a circuit including a particular semiconductor device, the model of that device may operate with variables such as electrode voltages and currents that are outside of its normal range. Some device models, such as models for diodes or bipolar transistors, exhibit strongly “non-physical” nonlinear behaviors which do not accurately correspond (during simulation of circuit operation) to the behavior of an actual physical device when operating outside of its normal modeling range.

There are many reasons for a device instance to be out-of-range during a simulation run. For example, large swings and overshoots during “less-accurate top-level” runs of the simulator for a particular circuit may cause out-of-range device instances. As another example, some behavioral models can be used to represent certain parts of the circuit for simulation. Those models could output very large currents or voltages that are “nonphysical” (i.e., would not be present in a real physical device of the kind being modeled), causing device instances connected to them to be out-of-range. Use of an unsuitable mathematical model for a device such as a diode or transistor may cause the simulator computations to fail to suitably converge.

The prior methods of voltage or current limiting (or other device parameter limiting) and the prior methods of discontinuity removal for device models have not been as effective as is desirable. For example, strongly nonlinear (i.e., strongly non-physical) behaviors of the circuit device occurring during a simulation typically cause various numerical computational difficulties for a circuit simulator. This typically causes longer simulation times, and sometimes causes the results of simulator computations to completely fail to converge, thereby causing the entire simulation run to fail. For example, the current in a diode having a large forward bias increases exponentially, and this may cause convergence difficulties for the simulator. In any case, when a simulation fails, integrated circuit designers often are forced to modify the options of the circuit simulation program or to even redesign the circuit. This is usually very time-consuming and costly.

Prior Art FIG. 1 is a copy of FIG. 5 in United States patent application “Continuous Parametric Model for Circuit Simulation” by Liu et al., Ser. No. 09/754,811 filed Jan. 4, 2001, published Jan. 31, 2002 as Publication Number US 2002/0013932, and entirely incorporated herein by reference. Prior Art FIG. 1 indicates a method of generating an enhanced continuous parametric device model for use in various SPICE simulators. The device model begins with the acquisition of a “base parametric model”, as indicated in block 505. The base parametric model is analyzed to determine whether the model is continuous over the desired full range of device variables, as indicated in decision block 510. If the base parametric model is not continuous, at least one compensation function is applied to “fix” or eliminate the discontinuity, as indicated in block 515. If the base parametric model is continuous, the method advances through a logical connector 520 to determine whether the derivatives of the base parametric model are continuous, as indicated in decision block 525. If the derivatives are not continuous, a compensation constant is applied to the parametric model to eliminate the derivative discontinuity, as indicated in block 530. After the derivatives have been found to be continuous or have been “fixed” or compensated to be continuous, the method concludes with the result being an enhanced or modified or replaced continuous parametric model, as indicated in label 540. The enhanced/modified/replaced continuous parametric model can be stored in model library for use by simulation/analysis engine software.

Thus, in accordance with Prior Art FIG. 1, a discontinuous, but not necessarily “strongly” nonlinear, base parametric model is “fixed” so as to change it into an enhanced/modified/replaced continuous parametric model. Note that the Liu et al. method “fixes” discontinuities, but does not fix strong nonlinearities in model equations. Known limiting algorithms deal with strong nonlinearities by limiting changes between Newton-Raphson iterations, but the model equations remain strongly nonlinear. (In contrast, the new technique of the present invention fixes strong nonlinearities by dynamically modifying or replacing strongly nonlinear equations with linear or “weakly nonlinear” equations, but does not fix discontinuities.)

In addition to the above mentioned Liu et al. published patent application, the most relevant prior art is believed to include material in Chapter 2 of “The Designer's Guide to SPICE and Specter” by Kundert, 1995, and the article “Augmentation of SPICE for Simulation of Circuits Containing Resonant Tunneling Diodes”, by Mayukh Bhattacharya, et al., IEEE transactions on computer-aided design of integrated circuits and systems, vol. 20, No. 1, January, 2001. (An introduction to the Newton-Raphson analysis method and convergence may be found in Kundert's above mentioned book.)

Thus, there is an unmet need for a simulator and technique for reducing the amount of time required to accurately simulate performance of circuits including strongly nonlinear device models.

There also is an unmet need for a simulator and technique which avoid the need for integrated circuit designers to modify options of a circuit simulation program as a result of a failure of computations in the simulation program to converge suitably.

There also is an unmet need for a simulator and technique which avoid the need for integrated circuit designers to modify the design of an integrated circuit as a result of a failure of simulation computations to converge suitably.

There also is an unmet need for a simulator and technique which reduce the time and overall cost required in the design of integrated circuits.

There also is an unmet need for a simulator and technique which avoid the need for “fixing” convergence problems associated with strongly nonlinear device models.

### SUMMARY OF THE INVENTION

It is an object of the invention to provide a simulator and technique for reducing the amount of time required to accurately simulate performance of circuits including strongly nonlinear device models.

It is another object of the invention to provide a simulator and technique which avoid the need for integrated circuit designers to modify options of a circuit simulation program as a result of a failure of computations in the simulation program to converge suitably.

It is another object of the invention to provide a simulator and technique which avoid the need for integrated circuit designers to modify the design of an integrated circuit as a result of a failure of simulation computations to converge suitably.

It is another object of the invention to provide a simulator and technique which reduce the time and overall cost required in the design of integrated circuits.

It is another object of the invention to provide a simulator and technique which avoid the need for “fixing” convergence problems associated with diode and bipolar transistor device models with exponential characteristics.

Briefly described, and in accordance with one embodiment, the present invention provides a simulation system (1) that prevents failure of simulation computations to converge due to out-of-range conditions of a first device model including a first equation (Eqn.(1)) utilized in simulation computations involving the first device model by identifying an out-of-range condition (e.g., v_{d}>V₀) which is likely to prevent convergence of simulation computations involving the first equation during a simulation run, and by automatically providing a second equation (Eqn.(6) or Eqn.(9)) in place of the first equation (Eqn.(1)), wherein the second equation defines a simpler mathematical function than the first equation and is more likely than the first equation to allow simulation computations to converge to a desired solution during the simulation run. The method includes automatically determining any time at which the out-of-range condition no longer exists and automatically modifying the first device model by replacing the second equation with the first equation.

In one embodiment, the invention provides a method for operating a simulation system (1) to prevent failure of simulation computations to converge due to out-of-range conditions of a first device model being simulated. The first device model includes a first equation (e.g., Eqn.(1)) utilized in simulation computations involving the first device model. The method includes: identifying an out-of-range condition (e.g., v_{d}>V₀) which is likely to prevent convergence of simulation computations involving the first equation during a simulation run; automatically providing a second equation (e.g., Eqn.(6) or Eqn.(9)) in place of the first equation (Eqn.(1)), wherein the second equation defines a simpler mathematical function than the first equation and is more likely than the first equation to allow simulation computations to converge to a desired solution during the simulation run; and also includes continuing the simulation run to obtain the desired solution.

In a described embodiment, the method includes automatically determining any time at which the out-of-range condition no longer exists and also includes automatically modifying the first device model by replacing the second equation with the first equation and then continuing the simulation run.

In one embodiment, the first equation is an exponential equation and the second equation is either a linear equation or a second order polynomial equation.

In one embodiment, the first equation represents a characteristic of a diode and is given by the expression

$${I}_{d} = {I}_{s} ( {e}^{\frac{{v}_{d}}{{V}_{te}}} - 1 ) ,$$

where v_{d} is the voltage across the diode, I_{d} is diode current, Iₛ is the saturation current, Vₜₑ=K*q/T, K is Boltzman's constant, q is the electronic charge, and T is temperature in degrees Kelvin.

In one embodiment, the second equation is selected from the group including linear (or first order polynomial) equations and second order polynomial equations.

In one embodiment, the method includes using the first equation during the simulation run whenever the first device model is not in an out-of-range condition and using the second equation during the simulation run whenever the first device model is in an out-of-range condition.

In one embodiment, the simulation system (1) is operated to prevent failure of simulation computations to converge due to out-of-range conditions of a plurality of device models in a circuit being simulated.

In one embodiment, the method includes forming a system of linearized equations representing a configuration of a circuit being simulated and using a Newton-Raphson analysis to perform the simulation computations. In one embodiment, values of parameters of the first device model are extracted parameters obtained by measurement of a physical implementation of the first device, and the method includes using the extracted parameters to identify the out-of-range condition.

In one embodiment, the method includes operating a SPICE circuit simulation program (3) included in the simulation system (1).

In one embodiment, the invention includes a simulation system (1) for preventing failure of simulation computations to converge due to out-of-range conditions of a first device model being simulated, the first device model including a first equation (e.g., Eqn.(1)) utilized in simulation computations involving the first device model. The simulation system (1) includes computing circuitry (2,3,18,26,27,30) for identifying an out-of-range condition (e.g., v_{d}>V₀) which is likely to prevent convergence of simulation computations involving the first equation during a simulation run; computing circuitry (18,20,22) for automatically providing a second equation (e.g., Eqn.(6) or Eqn.(9)) in place of the first equation (Eqn.(1)), wherein the second equation defines a simpler mathematical function than the first equation and is more likely than the first equation to allow simulation computations to converge to a desired solution during the simulation run; and computing circuitry (14,16,17,18,20,22) for continuing the simulation run to obtain the desired solution. In one embodiment, the second equation is either a linear equation or a second order polynomial equation, and the first equation is an exponential equation.

In one embodiment, values of parameters of the first device model are extracted parameters obtained by measurement of a physical implementation of the first device. In one embodiment, the simulation system (1) includes a SPICE circuit simulation program (3).

In one embodiment, the invention provides a simulation system (1) for operating a simulation system (1) to prevent failure of simulation computations to converge due to out-of-range conditions of a first device model being simulated, the first device model including a first equation (e.g., Eqn.(1)) utilized in simulation computations involving the first device model. The system includes means (2,3,18,26,27,30) for identifying an out-of-range condition (e.g., v_{d}>V₀) which is likely to prevent convergence of simulation computations involving the first equation during a simulation run; means (18,20,22) for automatically providing a second equation (e.g., Eqn.(6) or Eqn.(9)) in place of the first equation (Eqn.(1)), wherein the second equation defines a simpler mathematical function than the first equation and is more likely than the first equation to allow simulator computations to converge to a desired solution during the simulation run; and means (14,16,17,18,20,22) for continuing the simulation run to obtain the desired solution.

### BRIEF DESCRIPTION OF THE DRAWINGS

FIG. 1 is a copy of FIG. 5 in published United States Patent Application US 2002/0013932 published Jan. 31, 2002.

FIG. 2 is a block diagram of a circuit modeling and simulation system.

FIGS. 3A-E constitute a flowchart of a program for simulating circuits with out-of-range parameters and/or variables occurring in a device model.

FIG. 4A is a graph of the current through a simulated diode as a function of its voltage.

FIG. 4B is a graph of the conductance of the simulated diode represented by FIG. 4A as a function of its voltage.

### DETAILED DESCRIPTION OF THE PREFERRED EMBODIMENTS

In a described embodiment of the invention, if an operating parameter such as a voltage between two terminals of a modeled device such as a diode or transistor in a circuit simulation system is “out-of-range”, then the model is considered to no longer accurately describe its behaviors. To ensure numerical stability of the circuit simulator, the simulator automatically operates to identify any out-of-range variables which are likely to prevent convergence of simulation computations to a meaningful solution. If an out-of-range parametric condition or variable condition is detected, then the simulator automatically and dynamically substitutes a simpler mathematical function for the model which allows the simulation computations to converge suitably to a meaningful desired solution.

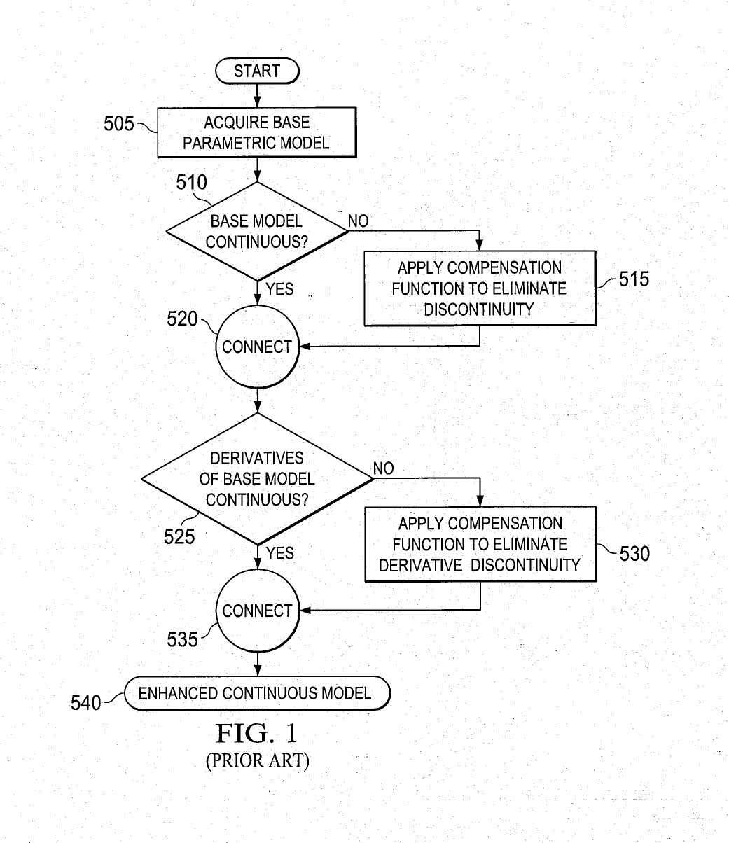

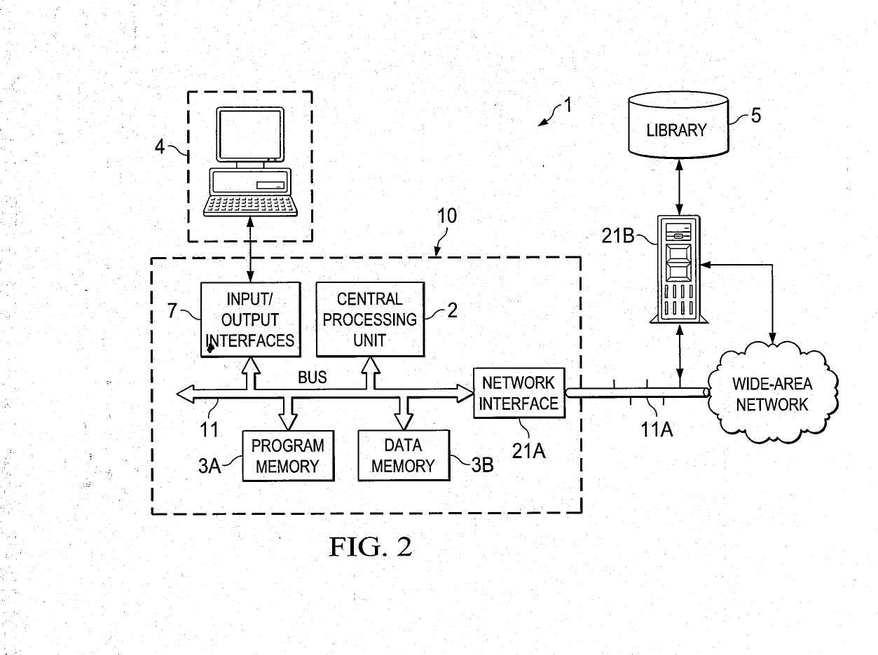

FIG. 2 is essentially similar to FIG. 1 in commonly assigned U.S. Pat. No. 8,200,461 entitled “Small-Signal Stability Analysis at Transient Time Points of Integrated Circuit Simulation” by the present inventor, filed Sep. 24, 2009 (published as US Publication 2011/0071812 on Mar. 24, 2011), and incorporated herein by reference. FIG. 2 is a simplified block diagram illustrating an exemplary computer simulation system 1 which can be used both to generate and utilize modified (or enhanced or replaced) device models to simulate electronic circuits and systems. System 1 includes a workstation 10 including a CPU (central processing unit) 2 which is operatively coupled by means of a bus 11, a network interface 21A, another bus 11A, and a server 21B to one or more computer-readable mass storage devices in a model library 5. Model library 5 may include disk drives and CD-ROM drives and the like, and stores both “base parametric models” and modified, replaced, or enhanced parametric models of circuit devices. Workstation 10 also includes a program memory 3A, a data memory 3B, and an input/output interface 7 each coupled to bus 11. Input/output interface 7 is coupled via a bus 8 to a peripheral function unit 4 which may include a keyboard, a digital pointer device such as a mouse, trackball, light pen, touch screen input device or the like, and a display device such as a LCD screen.

In FIG. 2, workstation 10 executes software instructions that are stored in one of its memory resources to represent an integrated circuit which is to be simulated. As is known for SPICE and similar simulation systems, the simulation of an electronic circuit is based on a set of circuit elements that are associated with selected “nodes” in an overall “netlist” that specifies the circuit which is to be simulated. Each circuit element is specified by a model which specifies the simulated behavior of that circuit element in response to input stimuli applied to the circuit element. Initial conditions to be applied at nodes of the modeled circuit for the purpose of simulating the transient response of that circuit may be input by the user via peripheral devices 4 or may be initial state data stored in model library 5. (For example, the time interval over which the transient response is to be analyzed is input via peripheral devices in block 4 or by retrieving a previously stored interval.) Conventional transient analysis is performed by time discretization over the selected time interval, wherein a system of equations descriptive of the modeled circuit is then solved in a piece-wise fashion at each of a sequence of discrete time points. The discrete transient time points within that interval are generally chosen by a time-stepping method (e.g., based on local truncation errors, break points, and the like).

As previously indicated, circuit components or devices used in conventional SPICE circuit modeling are described by mathematical models which generally are a collection of mathematical representations, such as input/output transfer functions, of various device parameters that characterize the devices/components. Such mathematical representations are referred to herein as “parametric models”. A particular circuit component/element may be represented by various base parametric device models. Data to be associated with a “base parametric device model” typically is collected or “extracted” by measurement of corresponding physical devices and is utilized in generating the device model, for example by “curve-fitting” of actual device data to equations utilized in the base parametric models. During a simulation run, if a base parametric device model operates outside of the range of the extracted physical device data utilized to generate that base parametric device model, it is considered to be “out-of-range” and therefore no longer valid. When that occurs, the base parametric device model equation is dynamically modified, i.e., enhanced or replaced, by a simpler equation that allows the simulator computations to converge.

There are many causes for the base parametric model of a semiconductor device in a circuit to be “out-of-range” during the simulation. At some point during the simulation, a base parametric device model may receive or generate very large representations of currents or voltages (or of parameters) that cause it to be “out-of-range” and therefore inaccurate. For example, sometimes designers run “top-level simulations” with very loose parameter tolerances, and this may cause the base parametric device model to experience large, out-of-range voltage swings or “overshoots”. In some cases, improper device models might be used for “less important” devices in the circuit being simulated. In some cases, “out-of-range” operation of a base parametric device model may be the result of a design error. In any case, whenever a base parametric device model is undergoing out-of-range of operation, it no longer can be considered to accurately describe the behavior of the corresponding actual physical device in the circuit being simulated.

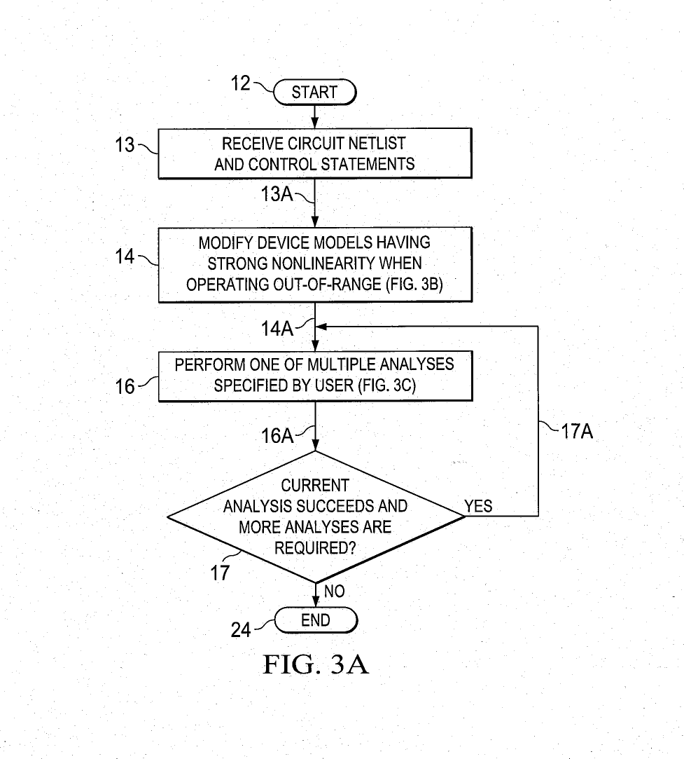

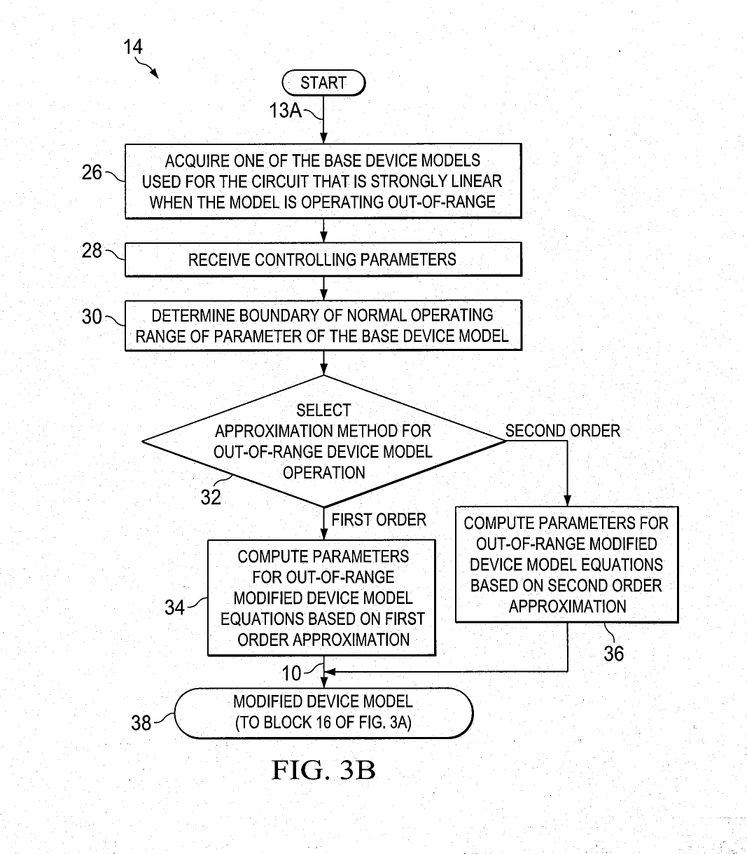

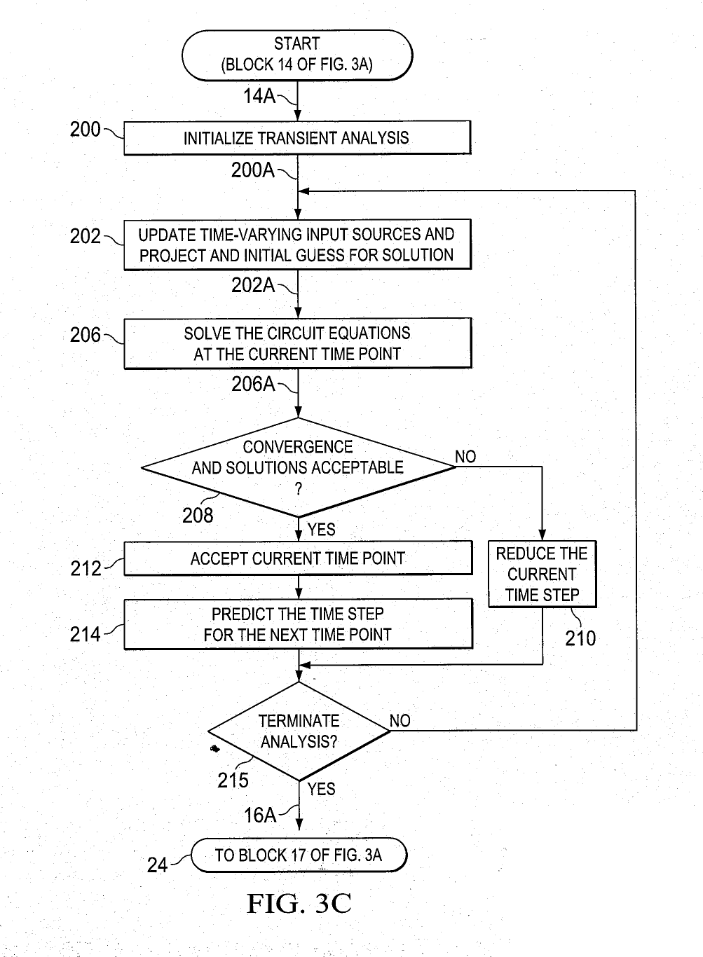

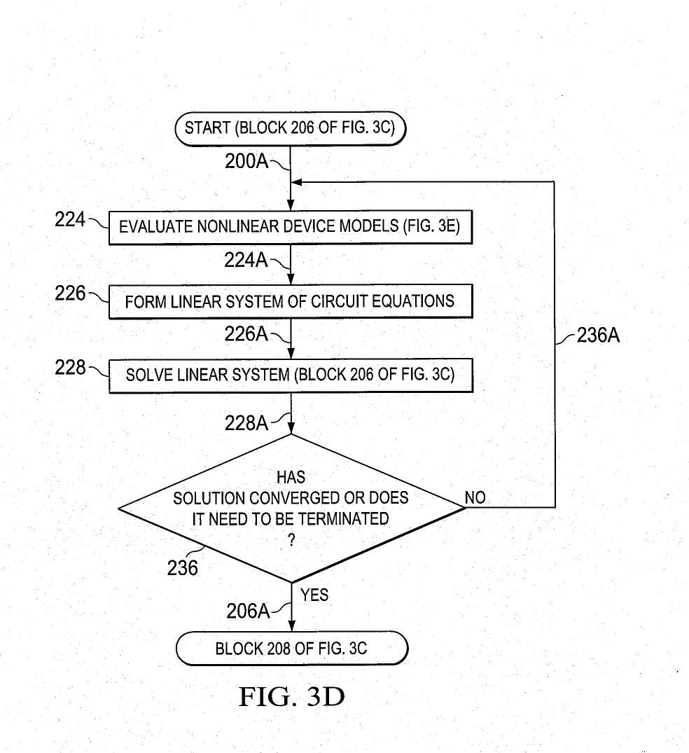

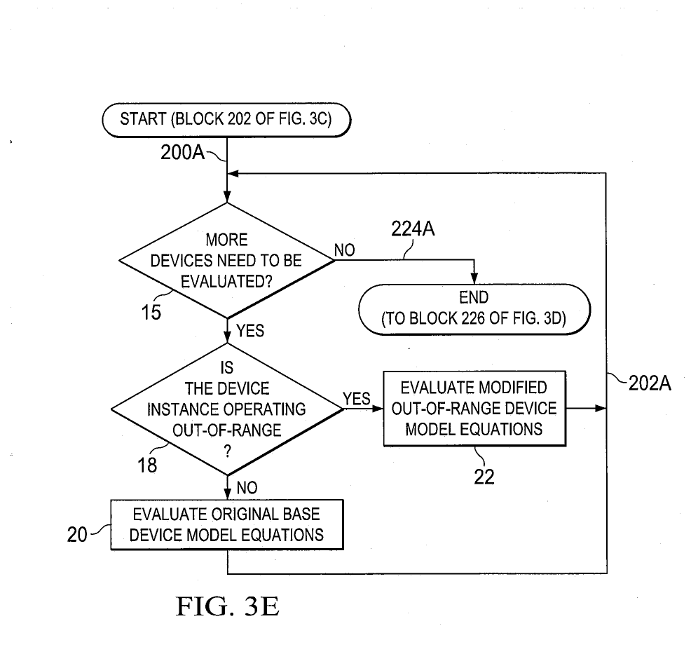

FIG. 3A shows a top-level flowchart wherein a START label 12 indicates the beginning of the overall process of simulating DC or transient operation of a particular circuit to be simulated (the structure of which has been entered by the user into simulation system 1). For example, the simulation program executed by simulation system 1 (FIG. 2) may receive a circuit netlist that includes a description of the appropriate circuit component model connections, and also may receive a “control statement”, as indicated in block 13. The control statement typically includes various device parameter tolerances, and also typically includes the desired number of circuit analyses and indicates whether they are AC analyses or DC analyses.

Referring to block 14, the simulation process modifies or enhances or replaces a base parametric device model as needed to provide a suitable simplified device model that allows simulation computations to converge whenever simulation system 1 finds that the base parametric device model is operating out-of-range. The simulation program evaluates all of the base parametric device models that are strongly nonlinear whenever they are operating out-of-range, so that the out-of-range device models can be modified or replaced by a linear or less nonlinear models for out-of-range of operation. Specifically, simulation system 1 dynamically modifies base parametric device models that exhibit strong nonlinearity beyond their normal operating range. Highly nonlinear device functions, such as exponential functions, are replaced by simpler functions such as first order linear or second order polynomial functions with more simulator-friendly numerical properties. Simulation system 1 then performs one or multiple DC and/or transient analyses as specified by the user. For example, during each specified analysis simulation system 1 repeatedly evaluates/computes instances of nonlinear device conditions (i.e., evaluates/computes current through a diode, forward voltage across the diode, and/or conductance of the diode) in the circuit being simulated. If a nonlinear device goes into an out-of-range condition at some point during the simulation, then simulation system 1 switches from the original nonlinear base parametric model to a specified linear function or second order function and uses it for as long as the modified device model remains in the out-of-range condition, and then returns to the original nonlinear base parametric model. (An “out-of-range condition” of a device model is defined such that the device model's terminal parameters and/or variables fall outside of the actual physical device values that have been utilized in the base parametric device model.) Details of steps performed in accordance with block 14 are described with reference to subsequently described FIG. 3B. (Various other operations performed by simulation system 1 are well known.)

Referring to block 16, the modified or enhanced or replaced device model (hereinafter referred to simply as “modified device model”) then is utilized to perform one or multiple DC and/or transient analyses using the modified/replaced device model. Specifically, the presently selected user-specified analysis is performed in accordance with the transient analysis process of subsequently described FIG. 3C. While an analysis is being performed, if a device model needs to be evaluated for an AC analysis, it is necessary to compute a DC operating point. That requires evaluating the nonlinear device models. To perform an AC analysis, it is necessary to linearize the associated device models at the DC operating point. (The operating point analysis can be (but does not need to be) a stand-alone analysis.) As indicated by decision block 17 in FIG. 3A, the simulation program next determines if the present analysis performed in accordance with block 16 is successful and if any further analyses are required. If the determination of decision block 17 is affirmative, the simulation program returns via flowchart path 17A to block 16 and performs the next user-specified analysis. If the determination of decision block 17 is negative, the overall simulation of the circuit under consideration is complete, as indicated by “END” label 24.

Details of the process of evaluating a device model as indicated in block 14 of FIG. 3A are shown in FIG. 3B, wherein the device evaluation program goes via path 13A from the start label to block 26 and acquires one of the device models from device library 5 (for example, a device model represented by subsequently described Equations (1) and (2)) used for the circuit being simulated from model library 5; that device model may show strong nonlinearity when operating out-of range. The program then goes to block 28 and receives specified controlling parameters. A controlling parameter can be at the circuit level or at the device level. For example, one circuit-level controlling parameter could be the maximum conductance for all the devices in the circuit. Another controlling parameter could be the maximum current for certain diode model.

The program then goes to block 30 and determines a boundary of the normal operating range for the device model under consideration, for example by using subsequently described Equation (3). Next, the program goes to decision block 32 and determines, on the basis of a user specified option, whether the present nonlinear base parametric device model should be modified or enhanced or replaced by a first order linear polynomial or a second order polynomial. If the determination of decision block 32 is that a first order polynomial should be used, the program goes to block 34 and computes appropriate parameters for out-of-range device mathematical functions, while maintaining continuity of the device functions and their first order derivatives. This results in a desired modified or enhanced or replaced device model, as indicated by path 10 and label 38. If the determination of decision block 32 is that a second order polynomial should be used, the program goes to block 36 and computes appropriate parameters for the out-of-range device. This results in the modified device model, as indicated by path 10 and label 38. The modified device model then is used in accordance with the process of block 16 in FIG. 3A.

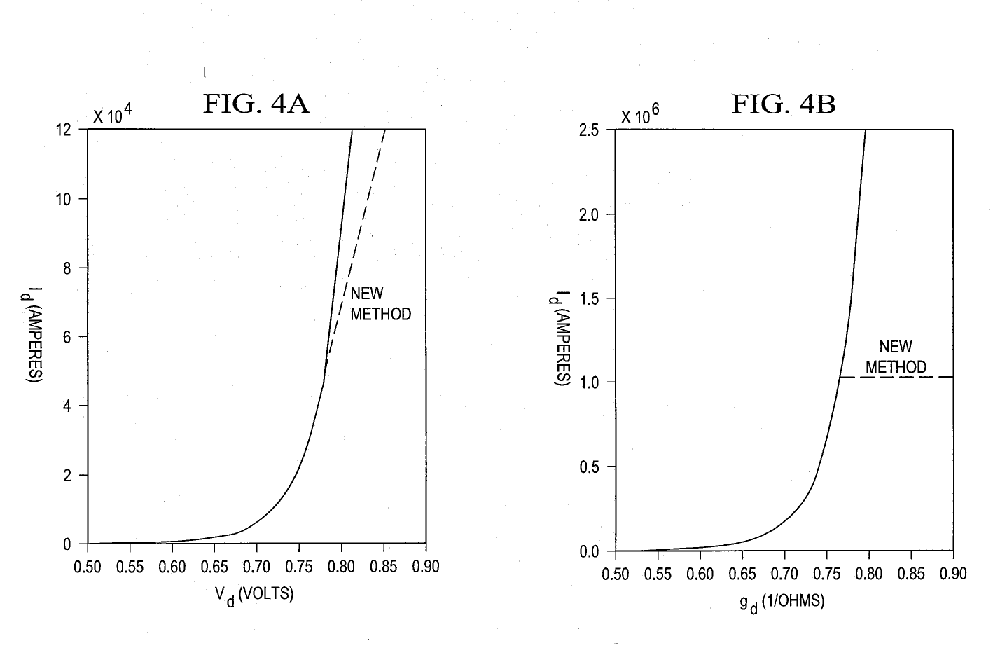

In one example, a diode model represented by Equations (1) and (2) below illustrates an original base parametric device model. Referring to block 26, simulation/analysis system 1 acquires this diode model from model library 5 (FIG. 2), with its current-voltage characteristics determined by Equation (1) and its conductance characteristics determined by Equation (2):

$$\begin{matrix}{I}_{d} = {I}_{s} ( {e}^{\frac{{v}_{d}}{{V}_{te}}} - 1 ) , and & Eqn . ( 1 ) \\ {g}_{d} = \frac{\partial {I}_{d}}{\partial {v}_{d}} = \frac{{I}_{s}}{{V}_{te}} {e}^{\frac{{v}_{d}}{{V}_{te}}} & Eqn . ( 2 )\end{matrix}$$

where v_{d} is the forward voltage across the diode, I_{d} is the diode current, g_{d} is the diode conductance, and Iₛ and Vₜₑ are model parameters. Iₛ is the saturation current. Vₜₑ=K*q/T, K is Boltzman's constant, q is electronic charge, and T is temperature in degrees Kelvin. (FIG. 4A shows a representative graph of diode current I_{d} according to Equation (1), and FIG. 4B shows a graph of the corresponding diode conductance g_{d}. The solid-line curves in FIGS. 4A and 4B represent Equations (1) and (2), respectively. The dashed line sections of the curves represent sections of the curves which have been dynamically modified in accordance with the present invention. Although both I_{d} and its derivative are continuous, they are strongly nonlinear for large values of v_{d}. For example, in FIG. 4A it may be seen that at approximately v_{d}=0.75 V (volts) the exponential diode model may be considered to be out-of-range, and from that point on the equation of a suitable “easy-to-converge” linear or polynomial function may be substituted in place of the original exponential function.)

Referring to block 28 in FIG. 3B for this example, note that simulation/analysis system 1 receives controlling parameters for modifying the diode model, including values for voltage, current, and conductance (e.g., Vmax=0.7 V, Imax=1 A (ampere), gmax=(1×10⁺³) mhos, as well as the choice (e.g., first-order or second order polynomial equation) of a substitute for the exponential expression in Equation (1).

Referring to block 30 in FIG. 3B, simulation/analysis system 1 in this example determines a boundary voltage V₀ of a “normal” operating range of forward voltage v_{d} for Equation (1) of the diode model, given by

$${V}_{0} = min ( {V}_{max} , {V}_{te} ln ( \frac{{I}_{max}}{{I}_{s}} ) , {V}_{te} ln ( \frac{{g}_{max} {V}_{te}}{{I}_{s}} ) ) , \qquad Eqn . ( 3 )$$

where V₀ is the smallest or minimum among the three voltages indicated within the brackets.

If operation beyond the boundary voltage V₀ is detected, simulation/analysis system 1 then computes corresponding modified device model parameters for the selected linear or second order out-of-range current equations for the diode model. If linear approximation is chosen in accordance with decision block 34, simulation/analysis system 1 uses Equations 4, 5, 6 and 7 (below) to compute the following parameters based on the continuity conditions of the diode current and diode conductance, as indicated in block 34:

$$\begin{matrix}{a}_{0} = {I}_{s} ( {e}^{\frac{{v}_{d}}{{V}_{te}}} - 1 ) , & Eqn . ( 4 ) \\ {a}_{1} = \frac{{I}_{s}}{{V}_{te}} {e}^{\frac{{V}_{0}}{{V}_{te}}} , & Eqn . ( 5 ) \\ {I}_{d} = {a}_{0} + {a}_{1} ( {v}_{d} - {V}_{0} ) , and & Eqn . ( 6 ) \\ {g}_{d} = {a}_{1} . & Eqn . ( 7 )\end{matrix}$$

However, if simulation/analysis system 1 determines in decision block 32 that second-order polynomial approximation is to be used to model I_{d} for out-of-range operation of the diode, then simulation/analysis system 1 computes the following model parameters as indicated in block 36 based on the continuity conditions of current, conductance, and second order derivative of the current equation,

$$\begin{matrix}{a}_{0} = {I}_{s} ( {e}^{\frac{{v}_{0}}{{V}_{te}}} - 1 ) , & Eqn . ( 4 ) \\ {a}_{1} = \frac{{I}_{s}}{{V}_{te}} {e}^{\frac{{V}_{0}}{{V}_{te}}} , & Eqn . ( 5 ) \\ {a}_{2} = \frac{{I}_{s}}{2 {V}_{te}^{{2}^{{e}^{\frac{{V}_{0}}{{V}_{te}}}}}} , & Eqn . ( 8 ) \\ {I}_{d} = {a}_{0} + {a}_{1} ( {v}_{d} - {V}_{0} ) + {{a}_{2} ( {v}_{d} - {V}_{0} )}^{2} , and & Eqn . ( 9 ) \\ {g}_{d} = {a}_{1} + 2 {a}_{2} ( {v}_{d} - {V}_{0} ) . & Eqn . ( 10 )\end{matrix}$$

Note that if the base model is continuous, then the continuity of the current and its derivative of the modified device model remains continuous.

FIG. 3C is identical to FIG. 2A of commonly assigned Published patent application “Method and System for Processing of Threshold-Crossing Events” filed Jun. 26, 2009 by the present inventor, published Dec. 31, 2009 as Publication No. 2009/0326882, and incorporated herein by reference. FIG. 3C is a flow diagram of a method for transient analysis of a circuit model in circuit simulation system 1 in FIG. 2. The transient analysis is performed over a time interval (0,T) that is computationally divided into discrete time points tₘ, where the time index m is the number of time points generated during the analysis. The start time and stop time for the time interval may be specified by the user. Modified nodal analysis of the modeled circuit is used to construct differential algebraic equations, and the time derivative terms of the differential algebraic equations are discretized to generate a system of nonlinear algebraic equations. The initialization may include predicting an initial time step h₁ for time index m=1 and generating a solution v₀ of the circuit equations for the first time point t₀ of the analysis for time index m=0. For ease of description, the assumption is made that the analysis begins at t₀=0 (or any other user-specified time point).

In FIG. 3C, the START label goes via path 14A from block 14 in FIG. 3A to block 200. In block 200, the simulation program first performs an initialization for the transient analysis in the present example. For example, a starting point (at which set the initial time might be set to zero) may be determined for a transient analysis that is to be performed. After the transient analysis is initialized, time points are generated (i.e., the nonlinear algebraic equations are solved) for each time index m and the transient analysis is terminated when the stop time T is reached. A time-varying input source provides an input stimulus signal, e.g., a voltage or current, having a value that is a function of time, so that the value of the input source may need to be adjusted when the current time point changes. To generate a solution at a time point tₘ, the time-varying input sources are updated to generate the input stimulus values, and an initial guess for the solution vₘ of the nonlinear algebraic equations at time point tₘ is “projected”, based on these updates and the solution(s) at previous time point(s). Note that at this point in the method, the time point tₘ is at a time step hₘ which is predicted either during the initialization process of block 200 or after acceptance of the previous time point tₘ₋₁ either as indicated in block 212 or as modified in block 210 if the solution to the nonlinear algebraic equations for the predicted time step fails to converge or is not acceptable.

Then, as indicated in block 202, the next time point for the varying input stimulus is updated and an initial “guess” at a reasonable value of the simulated solution for the next time step is determined. The initial guess for the solution vₘ may be determined by any suitable means, e.g., by extrapolation. As indicated in block 206, the circuit equations are solved at each time point. (Once the initial guess for the solution vₘ is determined, the nonlinear algebraic equations are solved at the current time point tₘ using a Newton-Raphson iterative method that is described below in more detail with reference to FIG. 3D. In general, the Newton-Raphson iterative method takes the initial guess for the solution and refines it iteratively making the guess more and more accurate in each iteration.)

If the iterative method converges on a solution vₘ and the solution vₘ satisfies any user-specified requirements according to block 208, the solution vₘ for the time point tₘ is accepted in accordance with block 212. The acceptance of a time point in accordance with block 212 includes outputting any information, i.e., results, a user has requested for a time point. The outputting may involve, for example, storing the requested results and/or providing the results to another software application and/or displaying the results in human readable form (e.g., on paper or on a display). Any data structures used for generating time points are updated based on the current time point.

The time step is then predicted for the next time point in accordance with block 214. The next time point and the solution at the next time point are then generated based on the new time step in accordance with blocks 202-214 unless some criterion for terminating the analysis (such as the stop time for transient analysis has been reached in accordance with decision block 215) has been met.

If the iterative method does not converge on the solution vₘ, or the solution vₘ does not satisfy any user-specified requirements according to block 208, the current time step hₘ is reduced, i.e., the current time point tₘ is moved closer to the previous time point. Another attempt is then made to generate the current time point tₘ unless some criterion for terminating the analysis has been met, such as the current time hₘ step being too small. If the simulated solution converges and is acceptable, as indicated by a “YES” determination by decision block 208, the current time point is accepted, as indicated in block 212. That predicts or determines the time step for the next time point, as indicated in block 214. If the determination of decision block 208 is “NO”, the program goes to block 210 and reduces the current time step. The program then goes to decision block 215, and if that determination is negative the program returns to updating the time varying input source(s) and determining another initial guess for the solution, as indicated in block 202. An affirmative decision by decision block 215 results in the program following path 16A to decision block 17 in FIG. 3A. (More details for blocks 200-206 are set forth in subsequently described FIG. 3D.)

FIG. 3D is a simplified version of FIG. 2B of the above-mentioned (and incorporated herein by reference) Publication No. 2009/0326882. FIG. 3D illustrates a simplified Newton-Raphson numerical analysis process flow, and shows a flowchart of a method for solving the system of nonlinear algebraic circuit equations at the current time point tₘ. The method is an iterative method based on the Newton-Raphson approach for solving nonlinear algebraic equations. In essence, the method attempts to converge on the solution vₘ at the time point tₘ. As previously explained (with reference to block 202 of FIG. 3C), the method begins with the projected initial guess for the solution vₘ at the current time point tₘ and iterates until there is convergence to a solution as determined in accordance with decision block 236.

In FIG. 3D, the START label comes from block 206 of FIG. 3C and evaluates all of the nonlinear models as described below with reference to FIG. 3E. After the nonlinear devices are evaluated, the linear system of equations is formed (typically represented in a matrix) that represent the integrated circuit being simulated, as indicated in block 226. More specifically, the nonlinear algebraic equations are linearized around the current solution vₘ^{k}. (Any suitable technique for forming the linear system of equations may be used.) The linear system of equations is then solved, as indicated in block 228 of FIG. 3D, to determine an update Δvₘ^{k+1} for the current solution vₘ^{k}. The solution vₘ^{k+1} for the next iteration k+1 is then computed as the sum of the current solution vₘ^{k} and the update Δvₘ^{k+1}. Then, in accordance with block 226, simulation system 1 forms a linear system. Then, in accordance with block 228, simulation system 1 solves the system of linearized equations.

The solution Δvₘ^{k+1} and other convergence criteria (e.g., Kirchoff's current law) are checked for convergence in accordance with decision block 236. If the decision of block 236 is affirmative, the solution has converged, and the program of FIG. 3D terminates and returns to block 208 of FIG. 3C. If the determination of decision block 236 is negative because solution has not converged, another iteration through blocks 224-228 is performed.

The flowchart of FIG. 3E illustrates the device evaluation process of block 224 of FIG. 3D. The START label in FIG. 3E therefore is the same starting point as in FIG. 3D, i.e., is the entry point of block 206 in FIG. 3D. The simulation program determines, in accordance with decision block 15, whether any more device models need to be evaluated. If that determination is affirmative, the program goes to decision block 18 and determines whether both the present device instance (i.e., device model) is operating out-of-range and a corresponding suitable modified device model is available. If the determination of decision block 18 is affirmative, then the simulation program goes to block 22 and evaluates (i.e., calculates) the modified out-of-range device model equations. If the determination of decision block 18 is negative, the simulation program goes to block 20 and evaluates the original base device model equations. In either case, the simulation program returns to decision block 15. If the determination of decision block 15 is negative, then the program returns to block 226 of FIG. 3D.

Thus, simulation system 1 (FIG. 2) automatically finds and identifies out-of-range conditions of the base parametric models of devices in the circuit being simulated and, if necessary, replaces or enhances or modifies highly nonlinear (and hence inaccurate) device functions (e.g., exponential functions) of the original base parametric models with linear and/or second order polynomial functions so as to preserve continuity and monotonicity of the original base parametric model. This technique greatly improves numerical stability of simulation system 1 and avoids convergence failures, and reduces simulator runtimes, thereby improving the robustness and the performance of the SPICE (or other) circuit simulation system 1.

This is in contrast to prior solutions such as changing simulator settings and/or modifying the circuit being simulated, which in effect are manual trial and error processes and are inherently highly inefficient, time-consuming, and costly. For example, the described technique of determining whether a device model is in an out-of-range condition does not require determining if the mathematical function in the model and/or its derivative are continuous, and does not try to “fix” such discontinuities as required by the prior art (as in the above mentioned published Liu et al. patent application). Instead, the described embodiment of the invention automatically replaces or modifies the original base parametric model by a simple first or second order polynomial function or the like so as to make the model less nonlinear. However, the described embodiment of the invention does not “fix” discontinuities of a device model.

While the invention has been described with reference to several particular embodiments thereof, those skilled in the art will be able to make various modifications to the described embodiments of the invention without departing from its true spirit and scope. It is intended that all elements or blocks which are insubstantially different from those recited in the claims but perform substantially the same functions, respectively, in substantially the same way to achieve the same result as what is claimed are within the scope of the invention.

What is claimed is:

1. A method for operating a simulation system to prevent failure of simulation computations to converge due to out-of-range conditions of a first device model being simulated, the first device model including a first equation utilized in simulation computations involving the first device model, the method comprising:
(a) identifying an out-of-range condition which is likely to prevent convergence of simulation computations involving the first equation during a simulation run;
(b) automatically providing a second equation in place of the first equation, wherein the second equation defines a simpler mathematical function than the first equation and is more likely than the first equation to allow simulation computations to converge to a desired solution during the simulation run; and
(c) continuing the simulation run to obtain the desired solution.

2. The method of claim 1 wherein step (a) includes automatically determining any time at which the out-of-range condition no longer exists and step (b) includes automatically modifying the first device model by replacing the second equation with the first equation and then performing step (c).

3. The method of claim 1 wherein the second equation is a linear equation.

4. The method of claim 1 wherein the second equation is a second order polynomial equation.

5. The method of claim 1 wherein the first equation is an exponential equation.

6. The method of claim 1 wherein the first equation represents a characteristic of a diode and is given by the expression
$${I}_{d} = {I}_{s} ( {e}^{\frac{{v}_{d}}{{V}_{te}}} - 1 ) ,$$
where v_{d} is the forward voltage across the diode, I_{d} is the diode current, Iₛ is the saturation current, Vₜₑ=K*q/T, K is Boltzman's constant, q is the electronic charge, and T is temperature in degrees Kelvin.

7. The method of claim 1 wherein the second equation is selected from the group including a first order linear equation and a second order polynomial equation.

8. The method of claim 1 wherein step (c) includes using the first equation during the simulation run whenever the first device model is not in an out-of-range condition and using the second equation during the simulation run whenever the first device model is in an out-of-range condition.

9. The method of claim 1 including operating the simulation system to prevent failure of simulation computations to converge due to out-of-range conditions of any of a plurality of device models in a circuit being simulated, the method including performing step (a) and step (b) for each device model.

10. The method of claim 1 including forming a system of linearized equations representing a configuration of a circuit being simulated and using a Newton-Raphson analysis to perform the simulation computations.

11. The method of claim 10 including determining if the simulation computations converge.

12. The method of claim 1 wherein the first device model includes a mathematical representation of the relationship between various device parameters which characterize a first device in a circuit being simulated.

13. The method of claim 12 wherein values of parameters of the first device model are extracted parameters obtained by measurement of a physical implementation of the first device, and wherein step (a) includes using the extracted parameters to identify the out-of-range condition.

14. The method of claim 1 including operating a SPICE-like circuit simulation program included in the simulation system to perform steps (a), (b), and (c).

15. A simulation system for preventing failure of simulation computations to converge due to out-of-range conditions of a first device model being simulated, the first device model including a first equation utilized in simulation computations involving the first device model, the simulation system comprising:
(a) computing circuitry for identifying an out-of-range condition which is likely to prevent convergence of simulation computations involving the first equation during a simulation run;
(b) computing circuitry for automatically providing a second equation in place of the first equation, wherein the second equation defines a simpler mathematical function than the first equation and is more likely than the first equation to allow simulation computations to converge to a desired solution during the simulation run; and
(c) computing circuitry for continuing the simulation run to obtain the desired solution.

16. The system of claim 15 wherein the second equation is either a linear equation or a second order polynomial equation.

17. The system of claim 15 wherein the first equation is an exponential equation.

18. The system of claim 15 wherein values of parameters of the first device model are extracted parameters obtained by measurement of a physical implementation of the first device, and wherein step (a) includes using the extracted parameters to identify the out-of-range condition.

19. The system of claim 15 wherein the simulation system includes a SPICE-like circuit simulation program.

20. A simulation system for operating a simulation system to prevent failure of simulation computations to converge due to out-of-range conditions of a first device model being simulated, the first device model including a first equation utilized in simulation computations involving the first device model, the system comprising:
(a) means for identifying an out-of-range condition which is likely to prevent convergence of simulation computations involving the first equation during a simulation run;
(b) means for automatically providing a second equation in place of the first equation, wherein the second equation defines a simpler mathematical function than the first equation and is more likely than the first equation to allow simulator computations to converge to a desired solution during the simulation run; and
(c) means for continuing the simulation run to obtain the desired solution.
